(19) United States
(12) Patent Application Publication
(10) Pub. No.: US 2012/0288598 A1
(43) Pub. Date: Nov. 15, 2012

(54) FIBER FORTIFIED CEREALS, CEREAL BARS AND SNACKS AND METHODS FOR MAKING

(76) Inventor: Steve Leusner, Chadds Ford, PA (US)

(21) Appl. No.: 13/538,065

(22) Filed: Jun. 29, 2012

Related U.S. Application Data
(63) Continuation-in-part of application No. 11/922,325, filed on Feb. 23, 2009, now abandoned.

(30) Foreign Application Priority Data
Jun. 17, 2005 (US) 60691263
Sep. 21, 2005 (US) 60718731
Jan. 10, 2006 (US) 60741059

(51) Int. Cl. A23L 1/308; A23P 1/08; A23L 1/18; A23L 1/10; A23L 1/164

(52) U.S. Cl. 426/291; 426/293; 426/304

(57) ABSTRACT

The disclosure relates to a method of fortifying a processed cereal piece with external fiber comprising: providing said processed cereal piece; using coating means, accritively coating said processed cereal piece with between 5.0% and about 50% w/w of the coated cereal piece with said fiber, wherein the step of coating comprise adding said processed cereal pieces into a coating means; separately adding fiber and an adhesive liquid to said coating means; and accritively increasing fiber content on the surface of the processed cereal piece in the coating means, wherein 30 grams of the coated processed cereal piece have less than or equal to 100 calories and shows substantially no clouding in 250 ml. cold water after 10 seconds.

### CROSS REFERENCE TO RELATED APPLICATIONS

This application is continuation-in-part of U.S. application Ser. No. 11/922,325, filed Feb. 23, 2009, which is a national phase entry from PCT International Application No. PCT/US2006/023754 having a 35 U.S.C. 371 date of Jun. 19, 2006, claiming priority from U.S. Provisional Patent Application No. 60/691,263, filed 17 Jun. 2005, U.S. Provisional Patent Application No. 60/718,731, filed 21 Sep. 2005 and U.S. Provisional Patent Application No. 60/741,059, filed 10 Jan. 2006, now expired, all which are hereby incorporated by reference in its entirety.

This disclosure relates to processed cereal grains or pieces fortified with one or more fiber types and a method of making the same. Specifically, the invention relates to a process to allow the production of high fiber ready-to-eat breakfast cereals, cereal bars, and snacks using any fiber source (soluble or insoluble or combinations) and any cereal base.

In addition, such fiber fortified product are made without a taste compromise, have better bowl life, retain their coating integrity when wet, and can be manufactured at substantially reduced product drying costs.

Ready-to-eat breakfast cereals are popular food items which provide a good source of nutrition. Typical ready-to-eat breakfast cereals are prepared in a variety of ways to provide different organoleptic characteristics, such as textures and mouthfeel. Such breakfast cereals include flaked cereals, puffed cereals, and shredded cereals. Ready-to-eat cereals are formulated primarily with cereal grains, and may contain one or more cereal grains. The cereal grains utilized, such as corn, wheat, rice, barley, and the like, have a high starch content but relatively little fiber. A breakfast cereal, as well as cereal bars, cookies, and various snack foods having reduced calorie load, as well as more fiber content, therefore, are desirable from a nutritional standpoint.

High fiber cereals have been produced by mixing powdered fibers in with the flour blends used to make breakfast cereals. Typically, either cracked grains or flour blends are put into either a steam cooker, extruder, or both to make cereals doughs which then may be formed into shapes or flakes before drying, toasting, and coating. There are numerous ways in which the steps can be combined to make breakfast cereals, but for high fiber cereals, the fiber is without exception added during the cooking step and becomes part of the dough mass. The addition of fiber to cereals is now limited because of fiber's tendency to absorb large amounts of water and to make resulting dough processing difficult if not impossible. Texture and bowl life of these cereals also tend to suffer. If fibers were to be added to the conventional sugar syrups used in breakfast cereal coatings in significant quantities as required, the viscosity would rise so as to be unpourable and unsprayable.

Additionally, flaked products made from whole grain or refined grain grits do not have the ability to be for fiber to be added internally. This invention allows these products to be fiber fortified.

There are a number of problems with the addition of fiber to cereals in the current processes; namely that the amount of fiber that can be added is limited due to cereal processing issues; and the palatability of resulting high fiber cereals is often poor because fiber addition interferes with flavor development during the cooking step for cereals.

The recent launch and subsequent withdrawal of “reduced sugar” cereals by all the large cereal manufacturers shows how difficult it is to manufacture cereals with a high fiber content while maintaining acceptable flavor characteristics. High fiber cereals can deliver not only much needed fiber in the American diet, but also two critically important emerging attributes: low glycemic load and reduced calories. Most RTE breakfast cereals contain little or no fiber, while there are some, like CHEERIOS™ that are about 10% fiber and deliver 3 g of fiber/30 g serving. High fiber cereals would be those delivering greater than 3 g per cereal serving.

Currently, the law allows products (e.g., 30 g/serving RTE breakfast cereals) which deliver 2.5 g/serving to be called a “good source of fiber” and those which deliver 5 g/serving to be called an “excellent” source. The disclosed methods are effective in creating products at the 2.5 g level, 5.0 g level and well beyond to levels of 12-15 g per prescribed food serving.

### SUMMARY

In one embodiment provided is a method of fortifying a processed cereal piece with a fiber comprising: providing said processed cereal piece; and coating said processed cereal piece with said fiber.

In another embodiment, provided is a processed cereal piece fortified with a fiber coating thereon.

In one embodiment, provided is a method of fortifying a processed cereal piece, a baked or a fried food with a fiber comprising: providing said processed cereal piece baked or fried food; and coating said processed cereal piece, baked or fried food with said fiber, wherein the coating comprises adding said processed cereal pieces, baked or fried food into a coating means, adding a fiber or a tackified fiber powder into said coating means, thereby fortifying said processed cereal piece baked or fried food.

In another embodiment, provided is a method of fortifying a processed cereal piece, a baked or a fried food with a fiber comprising: modifying the glass transition temperature (Tg) of a fiber to below the processing temperature; and coating said fiber onto the surface of said processed cereal piece baked or fried food, thereby fortifying said processed cereal piece baked or fried food.

In an embodiment provided is a fiber fortified processed cereal piece, having more than or equal to 5% fiber in 30 grams processed cereal piece, wherein the 30 grams processed cereal have equal to or less than 100 calories and shows substantially no clouding in 250 ml. cold (e.g. room 4° C. to 23° C.) water after 10 seconds.

In an embodiment, provided is method of fortifying a processed cereal piece with external fiber comprising: providing said processed cereal piece; using coating means, accritively coating said processed cereal piece with between 20% and about 50% w/w of the coated cereal piece with said fiber, wherein the step of coating comprise adding said processed cereal pieces into a coating means; separately adding fiber and an adhesive liquid to said coating means; and accritively increasing fiber content on the surface of the processed cereal piece in the coating means, wherein 30 grams of the coated processed cereal piece have less than or equal to 100 calories and shows substantially no clouding in 250 ml. cold (e.g. room 4° C. to 23° C.) water after 10 seconds.

### BRIEF DESCRIPTION OF THE DRAWINGS

The following drawings form part of the present specification and are included to further demonstrate certain aspects of the present disclosure. The disclosure and specification may be better understood by reference to one or more of these drawings in combination with the detailed description of specific embodiments presented herein and in which:

FIG. 1 shows comparative example 6 of a common method of fortifying cereals with 4 g fiber, leading to 30 g sample having 140 calories and showing clouding after as little as 10 seconds in 250 ml. water;

FIG. 2 shows comparative example 6 of a common method of fortifying cereals with 4 g fiber, leading to 30 g sample having 140 calories and showing increased clouding after as 30 seconds in 250 ml. water;

FIG. 3 shows comparative example 7 of a common method of fortifying cereals with 4.5 g fiber, leading to 30 g sample having 135 calories and showing clouding after as little as 10 seconds in 250 ml. water;

FIG. 4 shows comparative example 8 of a common method of fortifying cereals with 4 g fiber, leading to 30 g sample having 139 calories and showing increased clouding after 10 seconds in 250 ml. water;

FIG. 5 shows comparative example 9 of a common method of fortifying cereals with <6 g fiber, leading to 30 g sample having 120 calories and showing clouding after as little as 10 seconds in 250 ml. water;

FIG. 6, shows example 10 of the fiber-fortified, processed cereal piece where 30 g sample contain 6.0 g fiber having 99.6 calories showing no substantial clouding after 10 seconds;

FIG. 7 shows example 11 of the fiber-fortified, processed cereal piece where 30 g sample contain 6.0 g fiber having 97.5 calories showing no substantial clouding after 10 seconds; and

FIG. 8 shows example 12 of the fiber-fortified, processed cereal piece where 30 g sample contain 9.0 g fiber having 76.5 calories showing no substantial clouding after 10 seconds.

### DETAILED DESCRIPTION

The methods and processed cereal pieces disclosed herein provide a commercially viable method for producing ready-to-eat (RTE) cereals, cereal bars, and snacks with high fiber content, thereby, increasing health benefits to consumers, as well as in another embodiment, reducing glycemic load, or lowering sugar in another embodiment or reducing calories in another embodiment.

In one embodiment, the term glycemic index (GI) refers to a metric that measures how efficiently the body can metabolize carbohydrates. In another embodiment, it ranks carbohydrates by measuring the increase in blood sugar rises immediately after consuming the measured compound, and in one embodiment, tends to favor high-fiber foods that in another embodiment, take longer to digest.

In one embodiment, the term “dietary fiber” refers to the edible parts of plants or analogous carbohydrates that are resistant to digestion and absorption in the human small intestine with complete or partial fermentation in the large intestine. Dietary fiber include in one embodiment; polysaccharides, oligosaccharides, lignin and associated plant substances. In other embodiments, dietary fibers promote beneficial physiological effects, including laxation or blood cholesterol attenuation or blood glucose attenuation. In one embodiment, the term “Total dietary fiber” refers to bulk, or in another embodiment roughage, or in another embodiment bran, or in another embodiment to a collective term embracing various fiber types. In one embodiment, total dietary fiber includes two categories of fiber; which are in one embodiment insoluble dietary fiber (“IDF”) or in another embodiment, soluble dietary fiber (“SDF”), or in another embodiment, a combination thereof.

Several recognized analytical methods are known which, unfortunately, when applied to individual fiber materials can give widely varying values to the relative contribution of soluble vs. insoluble fiber and even, although with lesser variability, to total dietary fiber. For use herein, the fiber testing methods and characterizations are those described in “Determination of Insoluble, Soluble, and Total Dietary Fiber in Foods and Food Products: Interlaboratory Study” by Leon Prosky et al., J. Assoc. Off. Anal. Chem. (Vol. 71, No. 5, 1988).

According to this aspect, and in one embodiment, the methods and processed cereal pieces disclosed herein provide a method of fortifying a processed cereal piece with a fiber comprising: providing said processed cereal piece; and coating said processed cereal piece with said fiber.

In one embodiment, the term “processed cereal piece” refers to the process used to produce the RTE cereal. In another embodiment, that process produces flaked pieces, or in another embodiment, puffed cereal grain kernels, or in another embodiment, puffed dough pieces, or in another embodiment, extruded dough pieces, or in another embodiment, baked pieces, or in another embodiment, nuggets or in another embodiment, rolled grain pieces, or amylaceous cereal bars. A person skilled in the art would recognize that the process used for making any RTE cereal pieces, does not preclude the use of the disclosed methods, such as in another embodiment, in a process for manufacturing a ready-to-eat food bar comprising preparing of a dry mixture of particles or flakes of one or more cooked-extruded bases, comprising in one embodiment an amylaceous material or milk solids, or a combination thereof, mixing the dry mixture with a binder, comprising sugar, or milk solids or a binding agent or a mixture thereof, and forming the obtained mass into a bar shape.

Similarly, and in another embodiment, the methods of fiber fortification or supplementation according to the invention could be used on any baked item such as cookies and snack chips in one embodiment, or fried items such as potatoes or other vegetables in another embodiment. The skilled artisan will recognize that the invention can cover the addition of fiber to items when the preparation of these items, due to severe processing conditions either precludes the addition of the fiber directly to the processed cereal piece due to deterimental effects on either the processed item or the added fiber and combined additives. In one embodiment cookies, or crackers are coated according to the disclosed methods, resulting in cookies or crackers in which fiber content is increased by no less than 5% over their initial, inherent or formulated fiber content. In another embodiment, items for which the methods of fiber fortification or supplementation according to the methods provided are considered, can be foods intended for human or animal consumption such as baked goods, including in one embodiment bread, or wafers, cookies, crackers, pretzels, pizza, and rolls, hot cereals, pasta products, or snacks such as fruit snacks, salty snacks, grain snacks, confections and microwave popcorn in other embodiments.

In one embodiment, a binder is used to attach the fiber powder mixture to the processed cereal piece. In another embodiment, a binder is used in the process of making the cereal piece itself. In another embodiment, the term “binder,” refers to a syrup composition can act as an adhesive for combining relatively dry ingredients and temporarily causing the fiber powder to adhere to the food piece prior to it being overcoated with a “sealer” syrup. In one embodiment, the cereal piece or snack piece is lightly coated with a tackifying liquid after which time a fiber powder is added which then evenly coats and sticks to the food piece of interest. A second liquid such as water, sugar syrup, corn syrup, soluble fiber solution etc. is then added to the coating reel and allowed to coat the fiber coated pieces during tumbling. The addition of this second liquid causes the activation, swelling and hydration of the fiber particles causing them to form a fiber rich coating. The fiber coat then is overlaid in many cases with the second sugar or other coating prior to being dried to form a finished cereal or snack piece. In one embodiment, the syrup composition is a gelatin matrix comprised of gelatin, water, fat, syrup and sugars. In one embodiment, when mixed with other ingredients, the binder is also a source of protein. In one embodiment, the binders used in the methods provided contain vitamins, minerals and macronutrients, flavorings and colorings. In general, the disclosed methods and fiber fortified cereal pieces solves the problems associated with adding fiber to cereals, cereal bars, and snack pieces, by avoiding the contact of fiber with water until it has been evenly coated on the food piece. Once the cereal piece has been tackified by treatment with a liquid such as oil, water (including steam in one embodiment), sugar syrup, corn syrup, soluble fiber solution, molten wax, emulsifiers, gum solutions, etc. the fiber may be applied to surface where it will stick. The fiber is then activated or swollen in an even coating/layer by the subsequent addition of a water-containing syrup consisting of water, sugars, soluble fibers, etc. in order to create a finished coat which then is dried. In another embodiment, the sealing coat is in a molten state and comprises monomeric or polymeric compounds as described hereinabove.

In one embodiment, the term “tackified” refers to the modification of the surface of the cereal piece making it more amenable to absorption of fiber according to the disclosed methods. In one embodiment, applying liquid which favorably wets both the cereal piece and the fortifying fiber according to the disclosed methods, will tackify the cereal piece. In another embodiment, locally exceeding the Tg of a cereal piece, creating a rubbery state on the surface of the piece is considered tackifying the piece according to the disclosed methods. In one embodiment, tackifying the surface of the processed cereal piece, baked or fried foods, or the surface of the added fiber in another embodiment is done by making the surface more amenable to adhesion.

In one embodiment, the term “adhesion” refers to the holding together of two bodies by interfacial forces or mechanical interlocking on a scale of micrometers or less. In one embodiment, adhesion refers to chemical adhesion, or in another embodiment to interfacial adhesion. The term “chemical adhesion” refers in one embodiment to adhesion in which two bodies are held together at an interface by ionic, vander Waals, or covalent bonding between molecules on either side of the interface. The term “interfacial adhesion” refers in another embodiment to adhesion in which interfaces between phases or components are maintained by intermolecular forces, chain entanglements, or both, across the interfaces.

A person skilled in the art would recognize, that tackifying may be done to the fiber itself, rather than to the surface of the cereal piece, or baked or fried goods in other embodiments. In one embodiment, the fiber is added as a melt, thereby modified to be more amenable for absorption onto the surface of the cereal piece, baked or fried food as well.

In one embodiment, in addition to the flavoring added to the processed cereal piece itself, flavoring is added to the fiber coating used in the disclosed methods. In one embodiment, “flavoring” refers to an organoleptic agent in the form of an emulsion, concentrate, aqueous- or oil-soluble liquid or a dry powder, as well as any type of chunky piece or pieces that may be added to a mixture at any time in the process. In another embodiment, flavorings are considered additives and can include nuts, nut pieces, fresh fruits, dried fruits, fruit products, candies, marshmallows, “marbits,” chocolates and chocolate products, or a combination thereof. Flavorings include in one embodiment any fruit flavors such as berry flavors, or apple, cherry, plum, raisin, banana, pear, peach, figs, dates or combination thereof in other embodiments. Flavorings used in the methods provided in another embodiment include fats, or salts, honeys, cheeses, frosting, powdered food products, sugar, sugar substitutes, gelatins or spices in other embodiments. In one embodiment flavorings may also include colorings as well as any nut flavors as well as any sweet flavors such as chocolate, or vanilla, caramel, butterscotch, lemon, malt, cinnamon, graham, coconut flavors, mint or a combination thereof in other embodiments. Flavorings include in one embodiment any savory flavors such as all meat, or game, fowl, fish, dairy, barbecue, smoke, pepper, spicy, vegetable flavors, or combination thereof in other embodiments.

A person skilled in the art would readily recognize that the method of flavor processing can be modified to yield a flavor which in one embodiment may be added to the fiber being added to the fortified processed cereal piece, baked or fried foods according to the methods provided. Many flavor processing methods such as spray drying in one embodiment, or freeze-drying, coacervation, emulsification, encapsulation and the like or their combination, may be used with the disclosed methods.

In one embodiment, the flavor to the fibers according to the disclosed methods is spray-dried. Encapsulation employing the spray drying process requires that the active agent or encapsulant, in the form of an aqueous emulsion/solution with solubilized carrier solids, be fed into the spray dryer, atomized and dispersed into a heated air chamber plenum, dried, and collected. The resulting product is obtained as a fine particulate with the active agent dispersed within the porous particle matrix either as discrete droplets/particles or essentially dissolved in the matrix. The carrier solutes used in the emulsion preparation are required in one embodiment, not only to have emulsifying properties but also be bland, exhibit a high degree of solubility with low intrinsic viscosity, be non-reactive with the flavor load while retaining volatile components, and exhibit stable powder properties once dried. In one embodiment the carrier solutes of choice are selected for their emulsifying function and high degree of solubility. In another embodiment, the fine powder obtained is further agglomerated to yield a coarser powder, depending on the final application. In one embodiment, the spray dried encapsulated flavor added to the fibers according to the methods provided is processed to yield a particle size distribution that is similar to the particle size distribution of the added fiber.

In one embodiment, the term “similar to the particle size distribution” refers to average particle size that is between the average particle size of the added fiber+/−one standard deviation.

It is also noted and understood that particles sizes of a certain range may be beneficial for optimal adhesion. For example, lower particles sizes may be preferred for optimal adhesion.

In one embodiment, the flavor added to the fiber according to the disclosed methods is processed through melt extrusion of materials in carbohydrate matrices. In one embodiment, a carbohydrate melt is prepared and the encapsulate is added. The resulting solution is introduced into a quenching medium to produce a solid carbohydrate product containing the flavor. In one embodiment, the flavor encapsulate using melt extrusion process has a comparatively high boiling point since the carbohydrate solution is produced and delivered to the quenching medium at elevated temperatures. As mentioned herein and in another embodiment, the resulting encapsulated flavor can be further processed to yield a form which is compatible with the added fiber used in the disclosed methods.

In one embodiment, the flavor added to the fiber according to the disclosed methods is processed through coacervation encapsulation, a technology commercialized in the 1950s which, yields true controlled release functionality and has found wide usage in the pharmaceutical, fragrance and specialty products industries. In one embodiment, coacervation microcapsule systems used with the methods, can be generated in the form of simple coacervates, which are derived from a single polymer species in solution. In another embodiment, complex coacervates, which require the interaction of two distinct and oppositely charged polymer species, are also well characterized and are used in the disclosed methods. In one embodiment, complex coacervates are made using chitosan and cellulose.

In one embodiment, the term “active agent” or “active component” are interchangeable. In one embodiment, the term “active agent” refers to agents such as medications, pesticides, preservatives, vitamins, flavoring agents, perfumery chemicals and fragrances, and food colorants both synthetic and natural. Suitable medications include antacids, anti-inflammatory substances, coronary vasodilators, cerebral vasodilators, peripheral vasodilators, anti-infectives, psychotopics, antimanics, stimulants, antihistamines, laxatives, decongestants, vitamins, gastrointestinal sedatives, antidiarrheal preparations, antianginal drugs, antiarrhythmics, antihypertensive drugs, vasoconstrictors, migraine treatments, anticoagulants, antithrombotic drugs, analgesics, antipyretics, hypnotics, sedatives, antiemetics, antinauseants, anticonvulsants, neuromuscular drugs, hyper- and hypo-glycaemic agents, thyroid and antithyroid preparations, diuretics, antispasmodics, uterine relaxants, mineral and nutritional additives, antiobesity drugs, anabolic drugs, erythropoietic drugs, antiasthmatics, expectorants, cough suppressants, mucolytics, antiuricemic drugs and other drug substances such as topical analgesics, local anesthetics, and the like or their combination.

In one embodiment, the processed cereal pieces comprise nutraceuticals. In another embodiment the neutraceuticals used in the mixture coated with the fiber as described herein are insensitive to the methods used for coating the mixture and are able to withstand, in another embodiment, elevated temperatures without undergoing deteriorative changes, such that their efficacy is diminished by more than 5%. In one embodiment, the term “nutraceutical” refers to edible materials having, or believed at the time incorporated to have, medicinal effects. Nutraceuticals include in another embodiment tocopherols, B vitamins, ginseng or other herbs, wheat grass and barley grass and extracts of the grasses, soy-based estrogen analogs, minerals or combination thereof in other embodiments.

In one embodiment Nutraceutical components used in the fiber mixture or the processed cereal pieces used in the methods provided include components which promote health or prevent disease or enhance well-being such as antioxidants, phytochemicals, hormones, vitamins such as Vitamins A, B1, B2, B6, B12, C, D, E, K, pantothenate, folic acid, pro-vitamins, minerals such as calcium such as CaCO.sub.3 in one embodiment, selenium, magnesium salts, available iron, and iron salts, microorganisms such as bacteria, such as live lactobacilli, fungi, and yeast, prebiotics, probiotics, trace elements, essential and/or highly unsaturated fatty acids such as omega-3 fatty acids, and mid-chain triglycerides, nutritional supplements, enzymes such as amylases, proteases, lipases, lactases, pectinases, cellulases, hemicellulases, pentosanases, and phytases, pigments, oligopeptides, dipeptides, and amino acids, or mixtures thereof.

In one embodiment, the term “prebiotics” refers to a non-digestible food ingredient that beneficially affects the host by selectively stimulating the growth or the activity of one or a number of bacteria in the digestive system. In one embodiment, prebiotics refers to carbohydrates of relatively short chain length. Prebiotics are like other carbohydrates that reach the cecum, such as nonstarch polysaccharides in one embodiment, sugar alcohols, resistant starch, and hydrolyzed insoluble fiber, in being substrates for fermentation. In one embodiment the prebiotic substances used as part of the fiber mixture according to the methods provided are distinctive in their selective effect on the microflora. To be effective, prebiotics must reach the cecum in another embodiment.

In one embodiment, probiotics are added to the fiber mixture used in the disclosed methods. In one embodiment, the term “probiotics” refers to the resident bacterial population in the gastrointestinal tract, which has a major beneficial impact on gastrointestinal function and thereby on human health and well being. Among the probiotic bacteria, Bifidobacteria species are the most prominent. Bifidobacteria species, when in live and viable form, stimulate the immune system and exert a competitive exclusion of pathogenic and putrefactive bacteria, reduce the amounts of ammonia and cholesterol in the blood, and promote absorption of minerals. In one embodiment, Bifidobacteria exert a preventive action against colon cancer, by reducing the activity of some enzymes that convert procarcinogen substances into carcinogen substances. In one embodiment, probiotic bacteria added in an active culture as part of the fiber mixture according to the disclosed methods is lactic bacteria such as Lactobacillus bulgaricus, Lactobacillus acidophilus, Lactobacillus casei, Lactobacillus plantarum and Streptococcus faecium. In another embodiment Streptococcus thermophilus are also probiotic. These bacteria produce antagonist effects against pathogenic microorganisms, stimulate the immune system, improve lactose digestion, perform a lypolytic activity making fats more digestible, reduce plasmatic values of cholesterol, protect the intestinal mucosa ensuring an even assimilation of the nutritive substances, produce polysaccharides that are active on some tumors, and reduce viability of some enzyme-producing microorganisms catalyzing conversion of procarcinogen substances into carcinogenic substances. In one embodiment, the beneficial effects of probiotic microbes such as the Bifidobacterium species are in part due to their ability to ferment nondigestible sugars, such as hydrolyzed inulin in one embodiment, or prebiotic compounds in other embodiments.

In one embodiment, the fiber mixture used in the disclosed methods includes encapsulated active components. In another embodiment, the active components which may be encapsulated in accordance with the disclosed methods and fiber fortified cereal pieces are: acepromazine, acetaminophen, acetohexamide, acetohydroxamic acid, acetylcholine, acetylcysteine acyclovir, albendazole, alclometasone dipropionate, allopurinol, alprazolam, alprostadil, amcinoide, amantadine, amdinocillin, amikacin amiloride, aminocaproic acid, aminophylline, aminosalicylate, aminosalicylic acid, amitriptyline hydrochloride, ammonium chloride, amobarbital, amodiaquine hydrochloride, amoxapine, amoxicillin, amphetamine sulfate, amphotericin, ampicillin amprolium, acetazolamide acetyldigoxin, acetylsalicylic acid, anileridine, anthralin, antipyrine, antivenin, apomorphine, apraclonidine, ascorbic acid, aspirin, acromycin atropine, amoxycillin anipamil, azaperone azatadine maleate, azathioprine, azithromycin, aztreonam, bacampicillin, bacitracin, baclofen, barium salts, beclomethasone diproionate, belladonna extract, bendroflumethiazide, benoxinate hydrochloride, benzethonium chloride, benzocaine, benzonatate benzthiazide, benztropine mesylate, betaine, betamethasone, betaxolol, betanechol chloride, biotin, biperiden, bisacodyl, bismuth, botulism antitoxin, bromocriptine mesylate, bromodiphenhydramine hydrochloride, bumetanide, bupivacaine, busulfan butabarbital sodium, butalbital, combinations of butalbital, caffeine and aspirin and codeine, beta-carotene, calcifediol, calcium carbonate, calcium citrate, calcium salts, candicidin, captopril, carbachol, carbamazepine, carbenicillin indanyl sodium, carbidopa, carbinoxamine maleate, carboprost tromethamine, carboxymethyl cellulose, carisoprodol, casanthranol, cascara, castor oil, cefaclor, cefadroxil, cefamandole nafate, cefazolin, cefixime, cefoperazone, cefotaxime, cefprozil, ceftazidime, cefuroxime axetil, cephalexin, cephradine, chlorambucil, chloramphenicol, chlordiazepoxide, chloroquine phosphate, chlormadinone acetate, chlorothiazide, chlorpheniramine maleate, chloroxylenol, chlorpromazin, chlorpropamide, chlorprothixene, chlorprothixene, chlortetracycline bisulfate, chlortetracycline hydrochloride, chlorthalidone, chlorzoxazone, cholecalciferol, cholera vaccine, chromic chloride, chymotrypsin, cimetidine, cinoxazin, cinoxate, ciprofloxacin, cisplatin, clarithromycin, clavulanate potassium, clemastine fumarate, clidinium bromide, clindamycin hydrochloride, -palmitate and -phosphate, clioquinol, clofazimine, clofibrate, clomriphene citrate, clonazepam, cinnarizine, clonidine hydrochloride, clorsulon, clotrimazole, cloxacillin sodium, cyanocobalamin, cocaine, coccidioidin, cod liver oil, codeine, colchicine, colestipol, corticotropin, corisone acetate, cyclacillin, cyclizine hydrochloride, cyclobenzaprine hydrochloride, cyclophosphamide, cycloserine, cyclosporine, cyproheptadine hydrochloride, cysteine hydrochloride, danazol, dapsone, dehydrocholic acid, demeclocycline, desipramine, desoximetasone, desoxycorticosterone acetate, dexamethasone, dexchlorpheniramine maleate, dexpanthenol, dextroamphetamine, dextromethorphan, diazepam, diazoxide, dibucaine, dichlorphenamide, dicloxacillin sodium, dicyclomine, dienestrol, diethylpropion hydrochlorid, diethylstilbestrol, diflunisal, digitalis, dicoumarol, digitoxin, digoxin, dihydroergotamine, dihydrostreptomycin, dihydrotachysterol, dihydroxyaluminium amino acetate, dihydroxyaluminium sodium carbonate, diltiazem hydrochloride, dimenhydrinate, dimercaprol, diphenhydramine hydrochloride, diphenoxylate hydrochloride, diphteria antitoxin, dipyridamole, disopyramide phosphate, disulfiram, dobutamine hydrochloride, docusate calcium, docusate sodium, dopamine hydrochloride, doxepin hydrochloride, doxycycline, doxycycline hyclate, doxylamine cuccinate, dronabinol, droperidol, drotaverine, dydrogesterone, dyphylline, guaifenesin, enalapril maleate, analaprilat, ephedrine, epinephrine, equilin, ergocalciferol, ergoloid mesylates, ergonovine maleate, ergotamine tartrate, erythrityl tetranitrate, erythromycin, estradiol, estriol, estrogene, estrone, estropipate, ethcrynic acid, ethambutol hydrochloride, etlichlorvynol, ethinyl estradiol, ethionamide, ethopropazine hydrochloride, ethotoin, ethynodiol diacetate, etidronate disodium, etoposide, eugenol, famotidine, fenoprofen, ferrous fumatate, ferrous gluconate, ferrous sulfate, flucytosine, fludrocortisone acetate, flunisolide, fluocinolone acetonide, fluocinonide, fluorescein sodium, fluorometolone, fluorouracil, fluoxymesterone, fluphenazine, flurandrenolide, flurazpam, flurbiprofen, folic acid, furazolidone, flunitrazepam, furosemide, gemfibrozil, gentamicin, gentian violet, glutarate, glutethimide, glycopyrrolate, chorionic gonadotropin, gramicidin, griseofulvin, guaifenesin, guanabenz, guanadrelsulfate, halazone, haloperidol, haloprogin, halothane, heparin calcium, hepatitis virus vaccine, hetacillin potassium, hexylresorcinol, histamine phosphate, histidine, homatropine, histoplasmin, hydralazine hydrochloride, hydrochlorothiazide, hydrocodone bitartrate, hydrocortisone, hexobarbital, hydroflumethiazide, hydromorphone hydrochloride, hydroquinone, hydroxocobalamin, hydroxyamphetamine, hydroxychloroquine sulfate, hydroxyprogesterone caproate, hydroxyurea, hydroxine hydrochloride, hydroxine pamoate, hyoscyaamine, hyoscyamine sulfate, ibuprofen, ifosfamide, imipramide, imipramide hydrochloride, indapamide, indomethacin, insulin, inulin, iocetamid, iodoquinol, iohexol, iopamidol, ipecac, ipodate calcium, ipodate sodium, isocarboxacid, isoetharine hydrochloride, isoflurane, isoniacid, isopropamide iodine, isoproterenol hydrochloride, isosorbide dinitrate, isotretenoin, isoxsuprine hydrochloride, kanamycin sulfate, ketoprofen, ketoconazole, labetalol hydrochloride, lanolin, leucine, leucovorin calcium, levamisole hydrochloride, levocamithine, levodopa, levonorgestrel, levorphanol tartrate, levothyroxine sodium, lidocaine, lincomycin hydrochloride, lindane, liothyronine sodium, liotrix, lisinopril, lithium carbonate, loperamide hydrochloride, loracarbef, lonetil, lorazepam, lovastatin, loxapine, lysine, mafenide acetate, magaldrte, magnesium carbonate, magnesiumchloride, magnesium gluconate, magnesium oxide, other magnesium salts, malathinon, manganese salts, manganese, maprotiline hydrochloride, mazindol, measle virus vaccine, mebendazole, mebrofenin, mecamylamine hydrochloride, meclizine hydrochloride, meclocycline, meclofenamate sodium, medroxyprogesterone acetate, mefenamic acid, megestrol acetate, meglumine, melphalan, menadiol sodium diphosphate, menadione, menotropine, meperidine, mephenytoin, mephobarbital, meprednisone, meprobamate, mercaptopurine, mesoridazine besylate, mestranol, metaproterenol sulfate, metaraminol bitartrate, methacycline hydrochloride, methadone hydrochloride, methamphetamine hydrochloride, methazolamide, methdilazine, methenamine, methicillin sodium, methimazole, methionine, methocarbamol, methotrexate, methoxsalen, methoxyflurane, methsuximide, methyclothiazide, methylbenzethonium chloride, methyldopa, methylergonovine maleate, methylphenidate hydrochloride, methylprednisolone, methyltestosterone, methysergide maleate, metoclopramide, metolazone, meoprolol tartrate, metronidazole, metyrapone, metyrosine, mexiletine hydrochloride, mexiletine hydrochloride, miconazole, minocycline hydrochloride, minoxidil, mitomycin, mitotane, molindone hydrochloride, monobenzone, morphine sulfate, mupirocin, medazepam, mefruside, methandrostenolone, methylsulfadiazine, nadolol, nafcillin, nafcillin sodium, nalidixic acid, nalorphine, naloxone, nandrolone decanoate, nandrolone phenpropionate, naproxen, natamycin, neomycin, neomycin sulfate, neostimine bromide, niacin, nitrofurantoin, nalidixic acid, nifedipine, nitrazepam, nitrofurantoin, nitroglycerine, nitromerson, nizatidine, nonoxynol 9, norethindrone, norethindrone acetate, norfloxacin, norgestrel, nortriptyline hydrochloride, noscapine, novobiocin sodium, nystatin, opium, oxacillin sodium, oxamniquine, oxandrolone, oxazepam, oxprenolol hydrochloride, oxtriphylline, oxybenzone, oxybutynin chloride, oxycodone hydrochloride, oxycodone, oxymetazoline hydrochloride, oxymetholone, oxymorphone hydrochloride, oxyphenbutazone, oxytetracycline, padimate, panreatin, pancrelipase, papain, panthenol, papaverin hydrochloride, parachlorophenol, paramethasone acetate, paregoric, paromomycin sulfate, penicillamine, penicillin, penicillin derivatives, pentaerythritol tetranitrate, pentazocine, pentazocine hydrochloride, pentazocine salts, pentobarbital sodium, perphenazine, pertussis, phenacemide, phenazopyridine hydrochloride, phendimetrazine tartrate, phenelzine sulfate, phenmetrazine hydrochloride, phenobarbital, phenophtalein, phenoxybenzamine hydrochloride, phentermine hydrochloride, phenylalanine, phenylbutazone, phenylephrine hydrochloride, phenylpropanolamine hydrochloride, physostigmine, phytonadione, pilocarpine, pimozide, pindolol, piperazine, piroxicam plicamycin, poliovirus vaccine inactivated, polycarbophil, polymycin b sulfate, polythiazide, potassium chloride, potassium citrate, potassium cluconate, potassium iodine, potassium sodium tartrate, povidone iodine, pralidoxime chloride, pramoxine hydrochloride, pramezam, prazepam, praziquantel, prazosin hydrochloride, prazosin hydrochloride, prednisolone, prilocalne, primaquine, primidone, probenecid, probucol, procainamide hydrochiorid, procaine hydrochloride, procarbacine hydrochloride, prochlorperazine, prochlorperazine maleate, procyclidine hydrochloride, progesterone, proline, promazine, promazine hydrochloride, promazine, promethazine, promethazine hydrochloride, propafenone hydrochloride, propantheline, proparacaine hydrochloride, propoxycaine hydrochloride, propoxyphene hydrochloride, propoxyphene napsylate, propanolol hydrochloride, propyliodone, propylthiouracil, propylthiouracil, protriptyline hydrochloride, pseudoephedrine hydrochloride, pumice, pyrantel pamoate, pyrazinamide, pyrethrum extract, pyridostigmine bromide, pyridoxine hydrochloride, pyrilamine maleate, pyrimethamnine, pyroxylin, pyrvinium pamoate, phenacetin, phenytoin, prednisone, uinidine gluconate, quinidine sulfate, rabies vaccine, racepinephrine ranitidine, rauwolfia serpentina, resorcinol, ribavirin, riboflavin, rifampin, ritodrine, rubella virus vaccine, saccharin, saccharin sodium, salicylamide, salicylic acid, salsalata, scopolamine, secobarbital sodium, selenius acid, selenium sulfate, sennasenme, simethicone, sodium ascorbate, sodium bicarbonate, sodium fluoride, sodium gluconate, sodium iodide, sodium lactate, sodium nitrite, sodium ditroprusside, sodium salicylate, spironolactone, stannozolol, streptomycin, sucralfate, sulfacetamide, sulfadiazine, reserpine, sulfadioxine, sulfamerazine, sulfamethazine, sulfamethizole, sulfamethoxazole, sulfamethoxydiazine, sulfapyridin, sulfasalazine, sulfaperin, sulfathiazole, sulfisoxazole, sulfinpyrazone, sulindac, suprofen, stilains, tamoxifen citrate, temacepam, terbutaline sulfate, terfenadine, terpin, testolacton, testosterone, tolazamide, tolbutamide, tetracaine, tetracycline, tetrahydrocycline, theophylline, thiabendazole, thiamine hydrochloride, thiamin, thiamylal, thiethylperazine thimerosal, thioguanine, thioridazine hydrochloride, thistrepton, thiotepa, thiothixene, threonine, thyroid, ticarcillin, timolol, tioconazole, titaniumdioxide, tolazamide, tolbutamide, tolmetin, tolnaftate, trazodone hydrochloride, tretinoin, triacetin, triamcinolone, triamterene, triazolam, trichorfon, trichlormethiazide, trientine hydrochloride, trifluoperazine hydrochloride, triflupromazine, trihexyphenidyl hydrochloride, trimeprazine tartrate, trimethadione, trimethobenzamide hydrochloride, trimethoprim, trioxsalen, tripelennamine, triprolidine, trisulfapyrimidine, tropicamide, trypsin, tryptohan, tuberculin, tyloxapol, tyropanoate sodium, tyrosine, tyrothricin, thyrothricin bethamethasone, thiotic acid, sotalol, salbutamol, norfenefiine, silymarin, dihydroergotamine, buflomedil, etofibrate, indometacin, urea, valine, valproic acid, vancomycin hydrochloride, vasopressin, verapramil, vidarabine, vinblastine, vincristine, vitamins, warfarin, yellow fever vaccine, zinc acetate, zinc carbonate, zinc chloride, zinc gluconate, beta acetyl digoxin, piroxicam, haloperidol, ISMN, amitriptylin, diclofenac, nifedipine, verapamil, pyritinol, nitrendipin, doxycycline, bromhiexine, methylprdnisolone, clonidine, fenofibrate, allopurinol, pirenyepine, levothyroxin, tamoxifen, metildigoxin, o-(beta-hydroxyethyl)rutoside, propicillin, aciclovir mononitrate, paracetamol, naftidrofuryl, pentoxiflline, propafenone, acebutolol, L-thyroxin, tramadol, bromocriptine, loperamide, ketotifen, fenoterol, cadobelisate, propanolol, enalaprilhydrogen maleate, bezafebrate, ISDN, gallopamil, xantinol nicotinate, digitoxin, flunitrazepam, bencyclane, dexapanthenol, pindolol, lorazepam, diltiazem, piracetam, phenoxymethylpenicillin, furosemide, bromazepam, flunarizin, erythromycin, metoclopramide, acemetacin, ranitidin, biperiden, metamizole, doxepin, dipotassium chloroazepate, tetrazepam, estramustine phosphate, terbutaline, captopril, maprotiline, prazosin, atenolol, glibenclamide, cefaclor, etilfrine, cimetidine, theophylline, hydromorphone, ibuprofen, pnimidone, clobazam, oxaceprol, medroxyprogesterone, flecainid, pyridoxal 5 phosphate glutaminate, hymechromone, etofylline clofibrate, vincamine, cinnarizine, diazepam, ketoprofen, flupentixol, molsimine, glibornuride, dimetinden, melperone, soquinolol, dihydrocodeine, clomethiazole, clemastine, glisoxepide, kallidinogenase, oxyfedrine, baclofen, carboxymethylcysteine, thioridazine, betahistine, L-tryptophan, murtol, bromelaine, prenylamine, salazosulfapyridine, astemizol, sulpiride, benzerazide, dibenzepine, acetylsalicylic acid, iniconazol, nystatin, ketoconazole, sodium picosulfate, coltyramine, gemfibrocil, rifampicin, fluocortolone, mexiletin, amoxicillin, terfenadrin, mucopolysaccharide polysulfade, triazolam, mianserin, tiaprofenic acid, amezinium metilsulfate, mefloquine, probucol, quinidine, carbamazepine, L-aspartate, penbutolol, piretanide, aescin amitriptyline, cyproterone, sodium valproinate, mebeverine, bisacodyl, 5-aminosalicylic acid, dihydralazine, magaldrate, phenprocoumon, amantadine, naproxen, carteolol, famotidine, methyldopa, auranofine, estriol, nadolol, levomepromazine, doxorubicin, medofenoxate, azathioprine, flutamide, norfloxacin, fendiline, prajmalium bitartrate, lipid derivatives of phosphonatides, amphiphilic polymers, adenosine derivatives, sulfated tannins, monoclonal antibodies, and metal complexes of water soluble texathyrin, or combination thereof.

In one embodiment, the cereal piece is produced using a twin screw cooker extruder, which textures or in another embodiment cooks the ingredients with a combination of heat, mechanical shear and moisture addition. In another embodiment, flavours or in another embodiment, colouring are added directly into the barrel. The process is extremely flexible and enables the gelatinization of starch in the cereal to be accurately controlled. In one embodiment, the product is cooled in the second half of the extruder barrel, forming the pellets at the die face. The dough is discharged in another embodiment, through the die where, in one embodiment, it is cut into pellets. The pellets are conditioned in another embodiment by a stream of warm air before forming in a flaking roll or in another embodiment, in a shredding roll system, with final moisture removal and toasting achieved in one embodiment, in a continuous toaster.

In one embodiment, other extruder screw configurations may be used that facilitate low shear distributive mixing, such as screw elements of the type ZME, TME, SME, and so-called IGEL elements commercially available from Werner and Pfleiderer.

In another embodiment, rolls that are made from hardened alloy steel are mounted in a steel frame capable of exerting enormous pressure to flake the cereal piece. In one embodiment, the system has a hydraulic gap control or roll temperature control systems in another embodiment, to maintain consistent product quality throughout a production run. In one embodiment, hydraulic cylinders mounted at each end of the roll shaft maintain constant pressure on the product as it passes through the roll gap. Roll surface temperature is maintained in another embodiment, using cooling water pumped through channels just below roll surface.

In one embodiment, shredding is used as an alternative to flaking, designed to form in another embodiment, cooked cereal into layered shredded products or in another embodiment, to stranded type products, such as in one embodiment, shredded wheat. Cooked cereal is fed in one embodiment to a number of shredding roll mill units via an overhead recirculating and distribution screw. The screw flight feeds in another embodiment, individual shredding roll hoppers. The roll assembly has in one embodiment a grooved roll and a plain roll. The product is fed in another embodiment, through the roll nip to form a web of materials in one embodiment or strands of materials in another embodiment, separated from the roll by a comb scraper onto a conveyor underneath. In one embodiment, a number of pairs of rolls are used in series to lay webs on top of one another forming a multi-layered sheet. Up to 20 layers can be combined in another embodiment, with the option of introducing fillings between layers in another embodiment. For stranded products, the strands are cut in one embodiment, to length before drying. For shredded products, the finished sheet is crimped in one embodiment and cut to length in another embodiment. The crimper and slitter act in one embodiment, against a hardened roll. The product is then toasted.

In another embodiment, the methods and processed cereal pieces disclosed herein provide a method of fortifying a processed cereal piece with a fiber comprising: providing said processed cereal piece; and coating said processed cereal piece with said fiber, wherein, in another embodiment, the source of the cereal is corn, or wheat in another embodiment, or oat in another embodiment, or barley in another embodiment, or semolina in another embodiment, or rice in another embodiment, or tapioca in another embodiment, or yuca in another embodiment or a combination thereof in another embodiment.

In one embodiment, the methods and processed cereal pieces disclosed herein provide a method of fortifying a processed cereal piece with external fiber comprising: providing said processed cereal piece; using coating means, accritively coating said processed cereal piece with between 5% and about 50% w/w of the coated cereal piece with said fiber, wherein the step of coating comprise adding said processed cereal pieces into a coating means; separately adding fiber and an adhesive liquid to said coating means; and accritively increasing fiber content on the surface of the processed cereal piece in the coating means, wherein 30 grams of the coated processed cereal piece have less than or equal to 100 calories and shows substantially no clouding in 250 ml. cold (e.g. room 4° C. to 23° C.) water after 10 seconds, wherein in another embodiment, the source of said fiber is cellulose, or microcrystalline cellulose in another embodiment, or cocoa bran in another embodiment, or micronized corn bran in another embodiment, or oat bran in another embodiment, or oat fiber in another embodiment, or apple pulp in another embodiment, or pectin in another embodiment, or psyllium in another embodiment, or rice bran in another embodiment, or sugar beet pulp in another embodiment, or wheat bran in another embodiment, or soybean fiber in another embodiment, or hydrocolloids in another embodiment, or pea fiber in another embodiment, or wheat fiber in another embodiment, or inulin in another embodiment, hydrolyzed guar gun in another embodiment, inulin, or hydrolyzed inulin in another embodiment, or.beta.-2-1-fructofuranose materials in another embodiment, or liquid soluble corn bran Fibersol-2 LQ™ in another embodiment, or crosslinked modified (Fibersol-2™) or retrograded starch in another embodiment, or mixtures thereof in another embodiment.

Accretively increasing the fiber content on the surface of the processed cereal piece, refers to a growth process, where layers of fiber are deposited on top of each other in a surface normal deposition process. The process of increase in fiber content can exhibit a strong morphological plasticity due to imposed differences in coating conditions used. These conditions can include type of fiber (e.g. soluble and/or insoluble), type of binder/tackifying liquid, density and content of aerosolized fiber powder in the carrier air, location of addition of each and other like processing factors. Accordingly, while fiber slurry deposition is limited by the increase in viscosity with increased fiber concentration in the carrier as well as the available surface area, no such limitation exists when using the fiber accretion method provided herein.

Any pure fiber, or mixtures of fiber (soluble or insoluble) may be applied to any cereal or snack base piece in this manner. The locations of sprayed or poured adhesion syrup and metering in of a dry fiber source may be adjusted and optimized relative to the tumbling cereal base so as to create a continuous accretion of fiber rich coating. The coating reel thus stays clean and dry as an added benefit. Additionally, the final drying requirements for the finished cereal or snack piece are reduced due to the addition of dry material to the coating.

In one embodiment, enzymatic or in another embodiment heat are used to hydrolyze inulin into oligofructose biopolymer. Oligofructose is much more soluble than inulin wherein more than 750 g/l is soluble at 25.degree. C., vs. about 120 g/l at 25.degree. C. for inulin. In one embodiment, DP of oligofructose is between about 2 and 7. In one embodiment, oligofructose is used in the fiber mixture used in the fortifying methods, thereby increasing solubility of the fiber in the carrier fluid without increasing viscosity of the carrier fluid. It would be readily recognized by the skilled person in the art, that DP of the oligofructose could be optimized to yield the desired solubility, viscosity and sweetness in the final solution or suspension of fiber.

In one embodiment, the term “degree of polymerization” or “DP”, refers to The length in monomeric or base units of the average linear polymer chain at time t in a polymerization reaction.

$$DP = \frac{{M}_{t}}{{M}_{0}}$$

where: Mₜ=molecular weight at time t; and
M₀=molecular weight of one monomeric unit

In one embodiment, the mixture used in the disclosed methods also comprise additives, such as vitamins, oligoelements, microelements, peptides or combination thereof. A person skilled in the art will readily recognize that depending on the processing equipment used and process parameters used. the mixture coated with the fibers used in one embodiment, may further comprise other additives of beneficial nutritional value, which would not be adversely affected by the process. In processes where heat, moisture, salt content, pH or combination thereof, additives to the coating mixture used will be adversely affected, those additives may be added into the cereal piece formulation itself in one embodiment, or be pre-processed prior to the addition to the coating mixture in another embodiment, rendering these additives insensitive to the process used.

For example, when selecting soluble fibers for use in the adhering syrup, fibers of low viscosity can be chosen, such as liquid soluble corn branex. Fibersol-2 LQ, hydrolyzed inulin (BeneoOrafti P95™) or other low viscosity soluble fiber sources. The total accreted fiber content is the sum of fiber added in the dry state and in the liquid state as an adhesive spray. These are balanced along with added water, and sweeteners when desired to make the fiber coat integrally applied to the grain substrate.

In one embodiment, the term “additive” refers to any type of food ingredient added to the food product at any time during manufacturing. A “topping” is one type of additive which typically is disposed on “top” of the end product. In another embodiment, a “topping” is applied as a “coating” such that it adheres to some or all of the end product, with or without the assistance of a carrier substance. In one embodiment, liquids in any form are considered to be additives. Embodiments that discuss the use of “additive” can also include the use of any type of “topping.” Additives include in one embodiment, non-nutritive (non-carbohydrate) sweeteners (such as aspartame, acesulfame K, and saccharin) as well as carbohydrate-based sweeteners, and any other “carbohydrate” in other embodiments. Additives include in another embodiment acids, bases, salts, buffering systems, chelating agents, antioxidants, antimicrobial agents, gases/propellants, or combination thereof. Additives include in one embodiment nutrient and health additives such as vitamins, minerals, encapsulated biologically active components, nutraceuticals, dietary supplements, anti-oxidants, fibers, inulin, calcium carbonate, probiotic bacteria sprinkles (e.g., lactobacillus or acidophilus), energy additives, protein powders, powdered milk fractions, protein or satiety additives, herbs, aromatic substances, and other similar health-enhancing additives. In one embodiment, the additives used are hydrolyzed fibers, such as hydrolyzed guar gum in one embodiment, or hydrolyzed inulin in another embodiment.

In one embodiment, the vitamins and minerals added to the coating formulation or to the processed cereal piece in another embodiment are zinc or iron (mineral nutrients); a B vitamin (niacinamide); vitamin C (sodium ascorbate); vitamin A (palmitate); vitamin D, vitamin B.sub.6 (pyridoxine); vitamin B.sub.2 (riboflavin); vitamin B.sub.1 (thiamin mononitrate); vitamin B.sub.12; a B vitamin (folic acid), or a combination thereof. In one embodiment selenium as added to the mixtures used in the disclosed methods.

In one embodiment, coating further refines products in terms of taste, or visual appearance in another embodiment, or color in another embodiment or texture in another embodiment. In one embodiment, liquids metering and solids proportioning units allow the application of fat in one embodiment or water-based solutions in another embodiment, in combination with spices in one embodiment, or nut slivers in another embodiment. These systems guarantee a wide variety of solutions, thanks to heatable in one embodiment, or coolable drum types in another embodiment. In one embodiment, critical applications such as high-Brix coating of up to 98 Brix, are possible and are contemplated in the scope of this technology.

In one embodiment, the methods and processed cereal pieces disclosed herein provide a method of fortifying a processed cereal piece with a fiber comprising: providing said processed cereal piece; and coating said processed cereal piece with said fiber, wherein the coating comprises adding said processed cereal pieces into a coating means, adding an adhesive liquid to said coating means, creating an adhesive cereal mass, adding a fiber powder into said adhesive cereal mass; and drying said adhesive mass.

In one embodiment, emulsifiers are used in the adhesive liquid used in the disclosed methods. Emulsifiers which can be used include in one embodiment lecithin, or sorbitan monostearate, mono- and/or di-glycerides and polyoxyethylene sorbitan fatty acid esters, such as polysorbates (e.g., polyoxyethylene (20) sorbitan monostearate) or combinations thereof in other embodiments.

In one embodiment, syrup is used as the adhesive liquid, and in another embodiment, is metered into a coating drum and sprayed onto the cereal product being fed into the drum. In one embodiment, the tackifying liquid may be applied in the first half of a commercial coating reel and the “setting syrup” or “sealer coat” may be applied in the second half or back end of the coating reel. Alternatively, the tackifying and fiber application can be done in one reel and the second coating or “seal” coat can be done in a second reel before discharge to a dryer. Coated product is discharged in another embodiment continuously into the conveyor belt of a dryer before being packaged. In one embodiment, sprayed adhesive syrup and dry fiber addition are done simultaneously and continuously into the coating reel, so as to cause smooth continuous accretion of the fiber coat. The total fiber fortification is the sum of the adhesive coating fiber content and that added dry. Levels of each are controlled and selected o give the desired end fiber content desired.

In one embodiment, high solids coatings are used for frosted flakes or in another embodiment, lower solids for glazed flakes, or rice flakes in another embodiment, or directly expanded cereals in another embodiment. In one embodiment, the solids level of the syrup is 70% to 80%. In another embodiment, high solids systems are used when the moisture within the coating might migrate into the cereal and collapse the structure. In one embodiment, products such as puffed wheat require high solids coatings, which in another embodiment, contain about 98% solids. The appearance of the cereal may then be further controlled in the typical manner through the traditional judicious choice of sugar type, drying conditions and syrup concentrations. In one embodiment, due to the addition of the fiber to the coating mixture used in the disclosed methods, it is possible to increase the concentration of water in one embodiment, in the syrup without causing collapse of the cereal piece. Thinning of the sprayed adhesive coat may be achieved with heat, added diluents (e.g., water), or both to facilitate spraying. The concurrent dry fiber addition prevents collapse of the cereal piece by absorbing excess water prior to final drying.

In one embodiment, the fiber mixture used to fortify the processed cereal piece, or baked or fried foods in another embodiment, is a free flowing powder comprising the fiber mixture. In another embodiment, the free-flowing fiber mixture powder further comprises a flow agent which is silicon dioxide, starch, amorphous fumed silica, synthetic amorphous precipitated silica, fumed silica, calcium stearate, micronized silicon dioxide, sodium silicate, potassium silicate, sodium silicoaluminate-treated silica, or their combination.

In one embodiment, the speed of rotation or in another embodiment, the angle of inclination is variable and in one embodiment, the internal face of the drum is fitted with tumbling bars which flip material as it passes through the drum.

In one embodiment, metering of the free flowing powder, or alternatively dosing of emulsion, can be done sequentially along the coating means used in a way that maximizes desired properties of the fiber coating. In one embodiment, the fiber mixture is metered as discrete components along the process, such as in one embodiment, fiber components are added at the front of the coating means, followed by flavor additives at another entry point into the process, followed by nutritional additives as described herein in another entry point.

In one embodiment free flowing flavor is added to a tackified cereal piece, or fried or baked food, wherein through modification of the environment, the surface of the processed cereal piece or fried or baked food, is not tackified anymore, followed by metering of a tackified fiber mixture, wherein the tackified fiver mixture adheres to the processed cereal piece or fried or baked food, thereafter to be sealed with a sealer layer according to the methods of the disclosed methods.

In one embodiment, the coating system is comprised of two parallel helicoidal screws made in another embodiment, of soft fibers. In one embodiment, the two screws counter-rotate in a special 8-shaped trough. In one embodiment, the base product is fed in. In another embodiment, liquid or in another embodiment, powder ingredients or in another embodiment, a combination thereof, are metered from top of the open trough, at predetermined positions. Due to the rotation of the screws and in one embodiment, the product and the ingredients undergo a transfer and mixing effect which result in another embodiment, in a homogeneous coating.

In one embodiment, where coatings are applied to the processed cereal pieces or fried or baked items of the disclosed technology, conventional spray nozzles may be located close to the die for spraying an aqueous or alcoholic solution of the high fiber mixtures onto the cut pieces as they fall downwardly from the extruder die. In another embodiment, the fiber may be applied after drying of the pellets. In one embodiment, the fiber mixture is applied using spray nozzles, conventionally known fluidized bed coating apparatus, or other conventional coating apparatus and methods as described herein. Should the coating method used increase in one embodiment, the moisture content of the processed cereal piece, or baked or fried item to above that which is desired for shelf-life purposes, the water or plasticizer or other volatile media may be removed from the surface of the particles by additional drying.

In one embodiment, the coating method used for fortifying or supplementing the processed cereal pieces, or baked or fried items according to the methods provided is done using a fluidized bed method. In another embodiment the method is carried out in a wide variety of equipment such as a fluid bed drying apparatus. In one embodiment, dryer characteristics include fixed or vibrating; rectangular bed or round bed; and straight or serpentine dryers. Manufacturers of such dryers include Niro, Bepex, Spray Systems and Glatt. In another embodiment, an apparatus such as a fluidized bed is used for drying while an airlift is used for cooling once necessary. The air lift can also be used in one embodiment to force out “fine” items or pieces, so that they can be recycled.

The pieces or items of the disclosed methods and fiber fortified cereal pieces are passed in one embodiment into a fluid bed dryer having multiple internal “stages” or “zones”. A stage or zone is any discrete area within the dryer, and these terms are used interchangeably herein. The process conditions within a stage may be different or similar to the other stages in the dryer. It is understood that two adjacent dryers are equivalent to a single dryer having multiple stages. The various feed streams of granules and coating material can be added at the different stages, depending on, for example, the particle size and moisture level of the feed stream. Feeding different streams to different stages can minimize the heat load on the dryer, and optimize the particle size and shape as defined herein. In another embodiment, a different fiber mixture is coated in one dryer, for example soluble fiber, followed by a second dryer pass with a different fiber mixture.

In one embodiment, the fluid bed mixer considered for the methods, pieces or baked or fried items of present disclosed technology comprises a first coating zone where the pieces or items fiber coating material of the disclosed methods and fiber fortified cereal pieces is applied. The coating zone involves the spraying of the coating material in aqueous or slurry form as described in the embodiments herein, onto the fluidized pieces otr items. In one embodiment, the bed is fluidized with heated air in order to dry or partially dry moisture from the spray fiber coating as it is applied. The spraying is achieved via nozzles capable of delivering an appropriate amount of the coating mixture to achieve the desired coverage of the pieces or items of the disclosed technology. In another embodiment, the droplet size from the atomizer is less than about the particle size. This atomization can be achieved in one embodiment through a conventional two-fluid nozzle with atomizing air, or in another embodiment by means of a conventional pressure nozzle. To achieve this type of atomization, the solution or slurry rheology adjusted by varying temperature or composition or concentration of the components or their combination. While the nozzle location in the fluid bed may be in most any location, in one embodiment, the location is a positioning that allows a vertical down spray of the coating mixture such as a top spray configuration. In another embodiment, the nozzle location is placed at or above the fluidized height of the pieces or items of the disclosed technology in the fluid bed. The fluidized height is determined in one embodiment, by a weir or overflow gate height. The coating zone of the fluid bed is followed in another embodiment by a drying zone and a cooling zone. One of ordinary skill in the art will recognize that alternative arrangements are also possible to achieve the resultant coated pieces or items of the disclosed technology of the present disclosed technology.

In one embodiment, the disclosed methods are used in conjunction with well known cereal processes. Flakes made from whole grain or refined grain grits, which are not capable if being internally fiber fortified, may be fiber fortified using the coating processes described herein. In an embodiment, fiber is not added to the cereal during cooking, extrusion, puffing or other forming methodologies and is only added during the coating step. In another embodiment, no special or in one embodiment, new equipment is needed to produce the fiber fortified cereals of the disclosed technology.

In one embodiment, the methods and processed cereal pieces disclosed herein provide a method of fortifying a processed cereal piece with a fiber comprising: providing said processed cereal piece; and coating said processed cereal piece with said fiber, wherein the coating comprises adding said processed cereal pieces into a coating means, adding an adhesive liquid to said coating means adding free flowing fiber powder into said adhesive cereal mass, creating a coated adhesive cereal mass; and drying said adhesive mass, wherein in one embodiment, said adhesive liquid is oil or in another embodiment water or in another embodiment, a mixtures thereof. In one embodiment, the adhesive liquid described herein is used with the embodiments of the disclosed technology. In another embodiment, no oil is added and adhesive syrup which may contain soluble fiber sources and added dry fibers sources are added concurrently, or sequentially at specific locations in the coating reel to achieve a continuous and gradual accretion of coated fiber to specific levels, with specific compositions.

In one embodiment, the cereal piece is processed into an amorphous state, which exhibit the glass/rubber transitions characteristic of amorphous macromolecules. These materials have well defined glass transition temperature (Tg) ranges, which depend in one embodiment on the molecular weight or in another embodiment on the molecular complexity of the glass forming substance. Tg is depressed by the addition of diluents. Water is the universal plasticiser for all such hydrophilic materials. Therefore, the glass/rubber transition temperature is adjustable by in one embodiment the addition of water or an aqueous solution, or in another embodiment, the removal of water or an aqueous solution. In one embodiment, adding water at levels below that which reduces the operating temperature within the coating means to below the Tg of the amorphous parts of the processed cereal piece, does not induce collapse in the amorphous processed cereal piece.

In another embodiment, the term “collapse” refers to the inability of the cereal piece to support its own weight, or in another embodiment, its own volume. In one embodiment, collapse may be restricted to an external layer of the cereal piece, which in another embodiment may be in the range of 1 to about 10.sup.3.mu.m. In one embodiment, adhesion of fiber is achieved by locally reducing Tg to below the processing temperature, which in another embodiment reduces the local viscosity of the external layer of the cereal piece, thereby and in another embodiment, allows for the adhesion of fiber. A person skilled in the art would realize that the ability of fiber to adhere to the cereal piece does not necessarily depend on the ability of the adhesive liquid as described herein, to plasticizer the cereal piece. The term “plasticizer”, refers in one embodiment to the ability of the adhesive liquid to reduce Tg, or in another embodiment, to increase the free volume of the amorphous state.

In another embodiment, the plasticizer may be any substance of molecular weight lower than that of the cereal material typical polymer, which creates an increase in the free interstitial volume. In one embodiment, the plasticizer is an organic compound, which in another embodiment is a triglyceride of varying chain length, or in another embodiment, the plasticizer is water, or in another embodiment, a combination thereof, such as in one embodiment an emulsion.

In one embodiment, plasticizers employed in the disclosed methods and fiber fortified cereal pieces are any edible or consumable liquid which enables the formation of a substantially homogeneous cohesive, plasticized, viscoelastic, formable mixture, dough or mass being able to be manipulated further. In one embodiment, plasticizers used are water, or an aqueous-based composition such as a sugar solution, juice, alcohol, glycerol, sorbitol, oils, melted shortenings, fat, or mixtures thereof.

In one embodiment, no adhesive liquid is added to the coating prior to introduction of the fiber in the coating means. In this case, hot air is added to the coating means in such a way that the surface of the processed cereal exceeds the Tg, with viscosity of the surface falling about 2-6 orders of magnitude, such as in another embodiment, from about 10.sup.14 to about 10.sup.9 cPas, thereby allowing cohesion of the fiber powder onto the locally visco-elastic surface of the processed cereal piece. A person skilled in the art would recognize that there are many methods allowing for locally exceeding Tg without collapsing the whole processed cereal piece. In one embodiment, all methods which increase temperature locally to the point where the environment temperature is higher than the phase-corresponding Tg is contemplated as encompassed within the disclosed technology. In one embodiment, molecular weight average, concentration of components, relative humidity, presence of other plasticizers, process manipulation (e.g. steam injection) and the like or their combination, are used to tackify the surface of the processed cereal piece, or snack or cookie, allowing for adherence of the compositions of the disclosed technology and are used in the disclosed methods. The fiber coated piece may then be covered with a sealer coat (soluble fiber, sugar, etc,) to prevent and/or substantially delay rapid dissolution of the coating in cold water.

In one embodiment, the coating powder, comprising the fiber mixture is added as a suspension or as free flowing powder at the end of an extruder body, directly into a coating drum or by other incorporation means described herein.

In one embodiment, the disclosed technology surprisingly increases bowl-life of processed cereal pieces made according to the methods provided. In one embodiment, “bowl-life” is evaluated by placing a predetermined amount of cereal in a predetermined amount of cold milk maintained at fixed temperature. Sensory panelists make visual and organoleptical observations at fixed time intervals to determine when the cereal becomes unacceptable with regards to a given organoleptic attribute. In another embodiment, the ability of soluble fiber or insoluble fiber to absorb a plasticizer of interest before affecting the texture or integrity of the processed cereal piece itself, improves bowl life.

In one embodiment, the methods and processed cereal pieces disclosed herein provide a method of fortifying a processed cereal piece with a fiber comprising: providing said processed cereal piece; and coating said processed cereal piece with said fiber, wherein the coating comprises adding said processed cereal pieces into a coating means, adding an adhesive liquid to said coating means, creating an adhesive cereal mass, adding free flowing fiber powder (e.g. as an aerosol) into said adhesive cereal mass; and drying said adhesive mass, wherein said free flowing fiber powder comprises in another embodiment a fiber, or a carrier liquid or gas in another embodiment or sugars, corn syrups, or flavorings in another embodiment, or a combination thereof in another embodiment.

In an embodiment, provided herein is a method of fortifying a processed cereal piece with external fiber comprising: providing said processed cereal piece; tackifying the surface of said cereal piece, said fiber or both; and using coating means, coating said processed cereal piece with between 5% and about 50% w/w of the coated cereal piece with said fiber, wherein the step of coating comprises adding said processed cereal pieces into a coating means; separately adding fiber and an adhesive liquid to said coating means, creating an adhesive cereal mass, wherein the adhesive liquid is water, syrup, soluble fiber solution, sugar solution, oil or a mixture thereof, the oil being no more than 3 weight % based on the weight of the final processed cereal piece; and coating the processed cereal piece, wherein 30 grams of the coated processed cereal piece have less than or equal to 100 calories and shows substantially no clouding in 250 ml. water after 10 seconds. The term “cloudy” refers to a liquid that is not transparent. The distinction between transparent and cloudy beverages will be obvious to those of ordinary skill in the art.

In an embodiment, 30 grams of the final processed cereal piece have less than or equal to 95 or less than 80 calories and shows substantially no clouding in 250 ml. water after 10 seconds to 120 seconds, for example for 20 or 30 seconds, specifically 40 or 60 seconds, more specifically 90 or 120 seconds and any range in between.

In an embodiment, the fiber added is the only fiber used in calculating the final fiber content in the processed cereal piece and does not include any fiber inherently present or added to the formulation used in the processed cereal piece before the addition of the fiber.

The fiber added can be introduced into the coating means in a weight-less dry delivery auger, metering pump, as a slurry, suspension, dispersion or an aerosol (in other words, any preparation of a fine mist of particles, which can be in solution or a suspension, whether or not it is produced using a propellant. Aerosols can be produced using standard techniques, such as ultrasonication or high pressure treatment). In an embodiment, the tackifying liquid is added separately, or in other words not at the same time or the same location or both as the fiber used to fortify the processed cereal piece provided in the methods described herein. Accordingly, the liquid used to tackify the surface of the processed cereal piece, the fiber or both can be added simultaneously or sequentially to each-other. Thus, the fiber can be added as an aerosol suspended in air into the coating means at the sane time, before, or after the tackifying liquid, which can also be added as a fine mist or aerosol and can be any of the carrier liquids described herein. It should be noted that the addition of the various ingredients described herein (e.g., fiber, liquids, additives and the like) can be added according to the embodiments described.

In one embodiment, the fibers used in the methods described herein is suspended in a melt. As used herein, the term “melt” refers to a substantially pure compound, such as sugar and its derivatives, at temperatures above its melting temperatures. In another embodiment, the melt is a polymer, melt, such as the gums described herein.

In one embodiment, the methods and processed cereal pieces disclosed herein provide a method of fortifying a processed cereal piece, a baked or a fried food with a fiber comprising: providing said processed cereal piece baked or fried food; and coating said processed cereal piece, baked or fried food with said fiber, wherein the coating comprises adding said processed cereal pieces, baked or fried food into a coating means, adding free flowing fiber or a tackified fiber powder into said coating means wherein said free flowing fiber or tackified fiber powder comprises in another embodiment a fiber, or a carrier liquid and/or gas in another embodiment or sugars, corn syrups, or flavorings in another embodiment, or a combination thereof in another embodiment.

In one embodiment, the fiber powder added to the coating means according to the disclosed methods is humidified at room temperature, to the point where the processing temperature is above the fiber powder's Tg thereby rendering the powder sticky allowing the adhesion of the fiber onto the processed cereal pieces, baked or fried food.

The oil used in the methods provided should not be limiting and the oil used may be avocado, coconut, corn, cottonseed, fish oil, flaxseed, grape, olive, palm, peanut, rapeseed, safflower, sesame, soybean, sunflower oil, canola, mixtures thereof and the like. In one embodiment, the oil used in the disclosed methods and fiber fortified cereal pieces is soybean oil. In one embodiment, the oil used is medium chain triglycerides (MCT)

In another embodiment, the methods and processed cereal pieces disclosed herein provide a method of fortifying a processed cereal piece with a fiber comprising: providing said processed cereal piece; and coating said processed cereal piece with said fiber, wherein the coating comprises adding said processed cereal pieces into a coating means, adding an adhesive liquid to said coating means, adding free flowing fiber powder into said adhesive cereal mass thus creating an adhesive cereal mass coated with fiber; and drying said adhesive mass, wherein said fiber in one embodiment, is soluble fiber, or insoluble fiber in another embodiment or a combination thereof in another embodiment.

In one embodiment, the term “soluble fiber” refers to fiber that has an affinity for water, either dissolving in one embodiment, or swelling in another embodiment to form a gel. Soluble fiber includes gums, pectins, soluble corn bran, hydrolyzed inulin, or soluble highly crosslinked starch, or mucilages or some hemicelluloses, and is found in fruits or vegetables, or oats, or barley, or legumes, or seaweed or a combination comprising at least one of the foregoing. In one embodiment, soluble fiber acts to decrease the rate of stomach emptying and in another embodiment increase transit time, and in another embodiment, to bind bile acids, increasing their excretion. In another embodiment, soluble fiber increases the viscosity in the gut and acts in another embodiment, to reduce high blood cholesterol levels which in one embodiment, decreases the risk of cardiovascular disease.

In another embodiment, the term “insoluble fiber” refers to that which is not soluble in water, composed mainly of lignin in one embodiment, or cellulose in another embodiment, or hemicelluloses in another embodiment, and is primarily found in the bran layers of cereal grains; its actions include increasing fecal bulk in one embodiment and decreasing free radicals in the gastrointestinal tract in another embodiment. In one embodiment, the insoluble fiber is chosen which has a small non taste-detectable particle size and bland flavor so as to not affect the organoleptic properties of the cereal.

In one embodiment, the methods and processed cereal pieces disclosed herein provide a method of fortifying a processed cereal piece with a fiber comprising: providing said processed cereal piece; and coating said processed cereal piece with said fiber wherein the coating comprises adding said processed cereal pieces into a coating means, adding an adhesive liquid to said coating means, adding a powdered dry fiber into said adhesive cereal mass creating an adhesive cereal mass coated with fiber; and drying said adhesive mass. Liquid adhesive coating which may contain a soluble fiber source and the dry fiber source can be added at separate points in time and/or location, in sequential points in time or concurrently to achieve an accretion onto said cereal pieces.

In one embodiment, the components used in the disclosed methods, are substantially incorporated into the products made by the embodiments of the methods described herein.

In another embodiment, flavor of the grain portion of the cereal is unaffected by the methods of fiber fortification described herein, because there is no need to cook the fibers into the cereal, which impedes grain flavor and texture. Additionally a portion of fibers are “consumed” or destroyed during cooking, so higher levels can be needed to compensate. There is essentially no fiber loss with this new method of fiber fortification which leads to lower costs not only in final product drying but also in fiber required for fortification. In one embodiment, novel, good tasting high fiber cereals in one embodiment, with reduced calories in another embodiment and low glycemic load in another embodiment, or a combination thereof in another embodiment, are produced with similar taste profiles to low fiber cereals in one embodiment or no fiber cereals in another embodiment. In one embodiment judicious choice of fibers as well as by applying them in another embodiment, in a virtually non detectable manner creates a similar taste profile to low fiber cereals in one embodiment or to no fiber cereals in another embodiment. In one embodiment, fibers are chosen basically from any source such as soluble fiber in one embodiment, or insoluble fiber in another embodiment. In one embodiment BeneFiber™ (hydrolyzed guar gum) is chosen for its bland flavor in one embodiment and low viscosity in another embodiment, or a combination thereof in another embodiment.

In another embodiment, the methods and processed cereal pieces disclosed herein provide a processed cereal piece fortified with a fiber coating thereon. In one embodiment, the methods and processed cereal pieces disclosed herein provide a processed cereal piece produced according to the methods described in the embodiments hereinabove.

In an embodiment, the methods and products described provide a processed cereal piece fortified with a fiber coating thereon wherein said fiber coating content is between 0 and about 50% by weight, for example, 5.0 to 45% by weight, specifically 10 to 40% by weight or 15 to 35% by weight, more specifically 20 to 30% by weight or 25% by weight fiber. The fiber weight refers to the amount added according to the methods provided and not to the total fiber in the sample, which can be, for example the amount of fiber in 25 to 70 g of the processed cereal piece, specifically 25 to 50 g. fiber fortified cereal piece, more specifically, 25-35 g sample or 30 g. sample.

In one embodiment, the fiber coating content is between 0 and about 5% (w/w), or in another embodiment, between about 5 and about 10% (w/w), or in another embodiment, between about 10 and about 15% (w/w), or in another embodiment, between about 15 and about 20% (w/w), or in another embodiment, between about 20 and about 25% (w/w), or in another embodiment, between about 25 and about 30% (w/w), or in another embodiment, between about 30 and about 35% (w/w), or in another embodiment, between about 35 and about 40% (w/w), or in another embodiment, between about 40 and about 50% (w/w).

In one embodiment, the fibers of the disclosed technology, used in the methods and compositions of the disclosed technology are pre-dispersed in a carrier liquid in which the fibers are thermodynamically incompatible, at a concentration lower than that necessary to produce interactions among the fiber molecules. In another embodiment, the predipersion is achieved by means known in the field and could include high or low shear mixers, colloid mills and similar equipment. In one embodiment, the carrier liquid of the fiber is the same, or in another embodiment, similar to the liquid sprayed or coated onto the cereal piece, thereby inducing adsorption of the fiber onto the processed cereal piece through cohesion. In one embodiment, the fibers of the disclosed technology are added as free flowing powder mixture.

In one embodiment, the term “about” refers to a deviation from the range of 1-20%, or in another embodiment, of 1-10%, or in another embodiment of 1-5%, or in another embodiment, of 5-10%, or in another embodiment, of 10-20%.

The following examples are presented in order to more fully illustrate the preferred embodiments of the disclosed technology. They should in no way be construed, however, as limiting the broad scope of the disclosed technology.

### EXAMPLES

### Example 1

### Process for Making High Fiber Breakfast Cereal

### Finished Product Composition

The following is the finished product composition.

| Ingredient | Percent | Notes |
|---|---|---|
| Cheerios ™ | 80.21 | Store-bought product. |
| Raftilose P95 | 7.49 | A soluble fiber derived from inulin. (Orafti) |
| Benefiber ™ | 6.96 | Low viscosity guar gum. (Novartis) |
| Canola Oil | 2.67 | |
| Sucrose | 2.67 | |
| Total: | 100.00 | |

### Processing

The Cheerios™ pieces (150 g) were added to a rotating coating pan like those used to coat lab scale cereals. Five grams of canola oil was added to the tumbling cereal and allowed to wet the cereal surface. BeneFiber™ (13 g) was added to the tumbling cereal and allowed to stick to the cereal surface. A 75% solids solution was prepared consisting of 14 g Raftilose P95™, 5 g sucrose, and 8 g water. This solution was heated to boiling and then slowly poured over the tumbling cereal. After a short time tumbling, the cereal was dried at 245 F for 20 minutes. Tile resulting cereal was good tasting yet had an added fiber content of 15.5%. A serving of this cereal would thus have 15% less calories than Cheerios™ and deliver an extra 4.5 g of fiber per 30 g serving.

### Example 2

### Hi-Fiber Bar Cereal Bar

Procedure—Add cereal, protein crisps, and oats to coating pan. Add oil/flavor. Add fiber. Add liquids. Tumble till wet. Press into frame.

| Ingredient (s) Dry | g/bar | g/batch | Percentage |
|---|---|---|---|
| Cheerios ™ | 15.59 | 77.95 | 30.86% |
| Cellulose A23202 | 3 | 15 | 5.94% |
| Whey Protein Crisp 50 | 4 | 20 | 7.92% |
| Quick Oats | 2 | 10 | 3.96% |
| Raisins | 3.5 | 17.5 | 6.93% |
| Raftilose P95 ™ | 1 | 5 | 1.98% |
| 42 DE Corn Syrup | 18.35 | 91.75 | 36.32% |
| Glycerine | 1 | 5.00 | 1.98% |
| Soybean Oil | 1.5 | 7.50 | 2.97% |
| Ottens Maple Brown Sugar 11510 OS* | 0.08 | 0.40 | 0.16% |
| Water | 0.5 | 2.50 | 0.99% |
| | 50.52 | 252.6 | 100.00% |

Bars/Batch = 5
Dry at 210 F. for 10 mins with air on in oven.
*disperse in oil
Label 110904-2

### Example 3

### Mixed Berry Hi-Fiber Bar Cereal Bar

| Ingredient (s) Dry | g/bar | g/batch | Percentage |
|---|---|---|---|
| Berry Berry Kix ™ | 18 | 90 | 42.78% |
| 42 DE Corn Syrup | 13 | 65.00 | 30.89% |
| Sucrose | 3 | 15.00 | 7.13% |
| Raftilose P95 ™ | 3 | 15 | 7.13% |
| Raftiline HP ™ (inulin) | 2 | 10 | 4.75% |
| Water | 2 | 10.00 | 4.75% |
| Soybean Oil | 1 | 5.00 | 2.38% |
| Ottens Mixed Berry 13078 | 0.08 | 0.40 | 0.19% |
| | 42.08 | 210.4 | 100.00% |

Bars/Batch = 5

Cheerios are disposed in coating reel and tumbled. Oil is added and tumbled. Fibers are added and tumbled. Syrups/water/sugar/flavor are added. Slurry is pressed into frame and let dry/heat set at 220 F for 15 mins.

### Example 4

### Butter Vanilla Hi-Fiber Bar Cereal Bar

| Ingredient (s) Dry | g/bar | g/batch | Percentage |
|---|---|---|---|
| Kix ™ | 18 | 90 | 42.83% |
| Raftiline HP ™ (inulin) | 2 | 10 | 4.76% |
| Raftilose P95 ™ | 3 | 15 | 7.14% |
| 42 DE Corn Syrup | 13 | 65.00 | 30.93% |
| Water | 2 | 10.00 | 4.76% |
| Soybean Oil | 1 | 5.00 | 2.38% |
| Sucrose | 3 | 15.00 | 7.14% |
| Ottens Butter Vanilla 66-W | 0.03 | 0.15 | 0.07% |
| | 0 | 0.00 | 0.00% |
| | 42.03 | 210.15 | 100.00% |

Kix™ were provided into coating reel and tumble. Oil was added and tumble. Add fibers. Tumble. Add syrups/water/flavor. Press into frame and dry/heat set at 220 F for 15 mins.

### Example 5

### Butter Vanilla Hi-Fiber Bar Cereal Bar

Fortifying RTE Cereal with fiber or protein
to level of 5 g/30 g serving.

| Ingredient (s) Dry | g/batch | Percentage | Fiber % |
|---|---|---|---|
| RTE Cereal Base (ex. puff, shred, flake) | 150 | 80.43% | 0.00% |
| Raftilose P95 - hydrolyzed inulin | 7 | 3.75% | 3.75% |
| Soluble and/or Insoluble Fiber source or | 24 | 12.87% | 12.87% |
| protein source* | | | |
| Vegetable Oil | 5.5 | 2.95% | 0.00% |
| | 186.50 | 100.00% | 16.62% |
| Overcoat - Slurry Preparation | | | |
| g sucrose + Raftilose = | | | 7.00 |
| Total Slurry weight = | | | 14.00 |
| g water to add to make 50% solids = | | | 7.00 |
| Total Product Fiber or Protein (if | | | 16.62% |
| added at formula level) | | | |
| g fiber/serving = | | | 4.99 |

*Soluble/Insoluble fiber source may be chosen from any material which meet the food fiber definition including: inulin, cellulose, hydrolyzed guar (BeneFiber ™), bamboo fiber, beta-glucan, tomato fiber, wheat fiber, etc. Protein source may be soy, milk protein, or any other food grade protein source.

Procedure—Add cereal to coating reel. Allow to tumble and pour on oil. Slowly add the powdered fiber source to tumbling cereal. Heat overcoat slurry consisting of water and soluble Raftilose P95 to a boil. Pour overcoating sealing solution onto powder covered tumbling cereal. Tumble until well covered. Dry for 20 minutes at 215 F. Overcoat sealing solution may consist of Raftilose P95 (as in this example), water, sugar syrup, corn syrup, or any such combination so as to cover the fiber or protein layer. Resulting cereal will have a total fiber or protein content of 16.6 percent and will deliver 5 g of fiber (or protein) per 30 g cereal serving. Resulting cereal will also have a calorie content reduced by 16.6% by weight compared to original cereal if fiber was added at full level specified.

### Comparative Example 6

### 20% Oil Slurry Methodology 4 g. Fiber

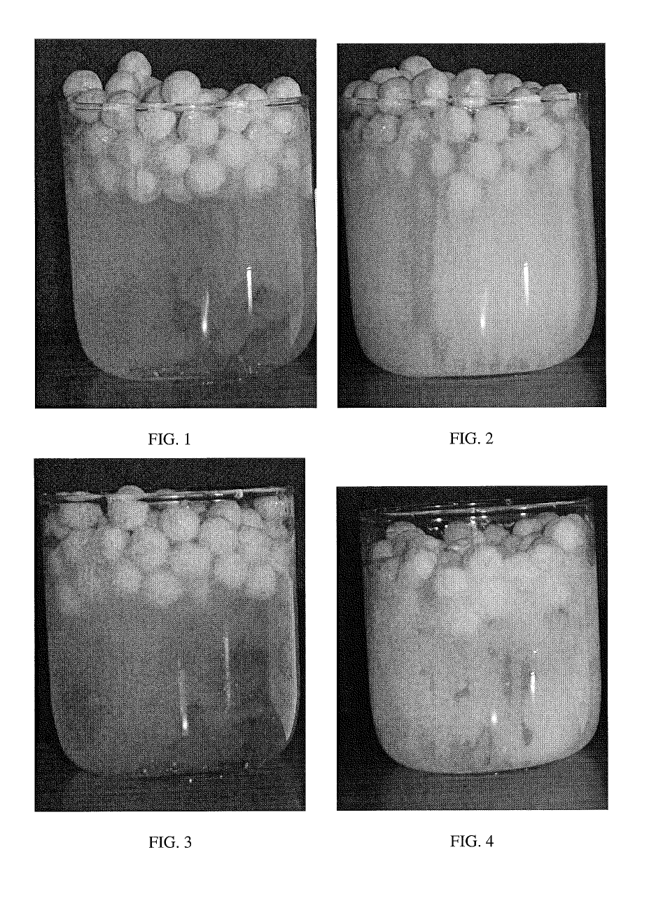

To compare current methods, using oil slurry deposition, the method used in U.S. Pat. No. 5,250,308 to Alexander et al., incorporated herein by reference in its entirety, was used to coat an extruded puffed cereal piece. As demonstrated in FIG. 1, samples providing 4 grams fiber in 30 grams processed cereal pieces were made using slurry with 20% oil. Samples were then added to 250 ml. of water to simulate milk. It is important to note RTE breakfast cereals typically retain their coatings in cold milk which extends bowl-life, crunchy texture, sweetness, and flavor. As a measure of the ability of the RTE breakfast cereals to retain the coating throughout the rte cereal's bowl life, the samples were evaluated by measuring the clouding of the water as a function of time. The longer the water can maintain their transparency, the less powder is sloughed off the processed cereal piece. The sample resulted in a coated puffed piece with 140 calories per 30 grams sample. As shown in FIGS. 1 and 2, the coating has disintegrated after only 10 seconds in cold water. The fiber particles have hydrated, swelled, and sloughed to the bottom. (cloudiness). Once sloughing ended, the cereal base was examined and was totally devoid of coating, became mushy in texture almost immediately. This observation were made at a relatively low level of 4 g fiber per serving namely, at around 11% w/w fiber per RTE cereal piece. As shown in FIG. 2, fiber sediment was visible at the bottom of the water container after as short as 30 seconds.

### Comparative Example 7

### 20% Oil Slurry Methodology 4.5 g. Fiber

As demonstrated in FIG. 3, fiber content of the samples in comparative example 6, were increased to 4.5 grams fiber in 30 grams processed cereal pieces, using slurry with 20% oil. Samples were likewise added to 250 ml. of water to simulate milk.

Just as in C.Ex 6, the coating has disintegrated after only 10 seconds in cold water. The fiber particles have hydrated, swelled, and sloughed to the bottom. (cloudiness). Once sloughing ended, the cereal base was examined and was totally devoid of coating, became mushy in texture almost immediately. This observation were made at a relatively low level of 4.5 g fiber per serving namely, at around 15% w/w fiber per RTE cereal piece. As shown in FIG. 3, fiber sediment was visible at the bottom of the water container after as short as 30 seconds. The sample resulted in a high-calorie coated puffed piece with 135 calories per 30 grams sample.

### Comparative Example 8

### 20% Oil Slurry Methodology 4 g. Fiber

To validate the results observed in C.Ex. 6, comparative example 9 repeated the method.

Just as in C.Ex. 6, the sample resulted in a coated puffed piece with 139 calories per 30 grams sample. As shown in FIG. 4, the coating has disintegrated after only 10 seconds in cold water. hydrated swollen fiber particles sloughed to the bottom. (cloudiness). This observation were confirmed at a relatively low level of 4 g fiber per serving namely, at around 11% w/w fiber per RTE cereal piece.

### Experimental Examples 9

### 2% Oil Slurry Methodology <6 g. Fiber

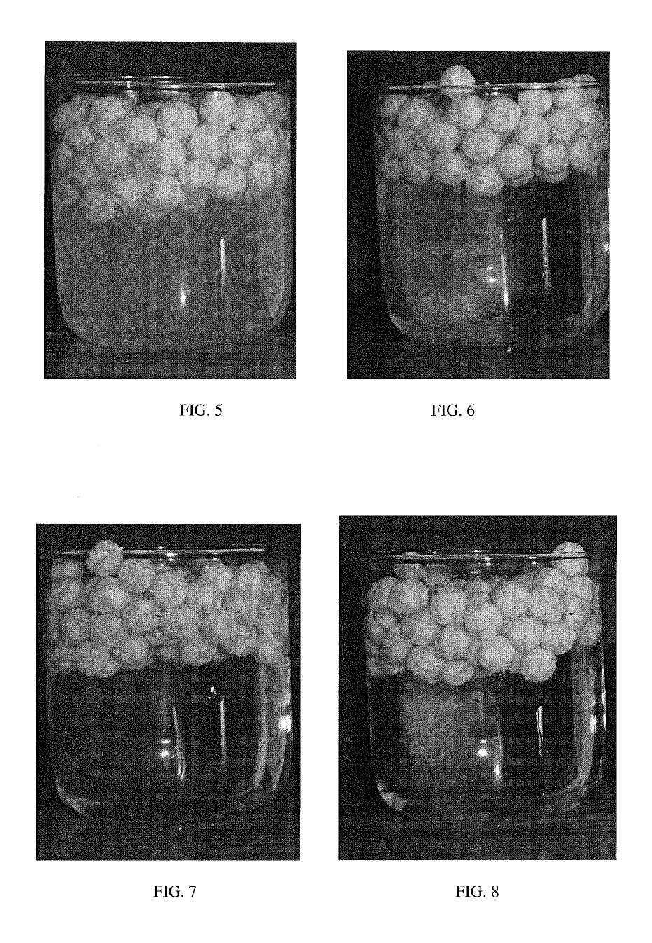

In this example, low levels of oil were used (2%) in order to assess feasibility of low levels of oil to adhere fiber. The fiber was observed not to stick evenly to the puffs and most of the fiber was left loosely adhered or remained in the coating pan. As shown in FIG. 5, the fiber portion that did adhere was observed to be sloughing off into the cold water immediately. The sample resulted in a coated puffed piece with 120 calories per 30 grams sample.

### Experimental Examples 10 and 11

### 6 g. Fiber (20% Fiber w/w)

Experimental samples using the powder accretion method described hereinabove with a sealant layer were used to coat the same puffed RTE cereal pieces used in C.Ex 6-9. Results shown in FIGS. 6 and 7 where a 30 g. sample with 6 g. of fiber (i.e. 20% w/w) has 99.6 and 97.5 calories and shows no substantial clouding after 10 seconds, indicating the integrity of the coating is retained in the cold water sample. No clouding was observed even after several minutes. Texture and flavor were likewise typical of RTE cereals.

### Experimental Example 12

### 9 g. Fiber (30% Fiber w/w)

The amount of fiber added was increased from examples 10 and 11 to 30%. 30 g. samples had 76.5 calories. As shown in FIG. 8, samples containing double the amount examined in C.Ex. 7 and more than 150% the amount examined in C.Ex 9, shows coating integrity reflected by the transparency of the water after 10 seconds (and maintained for several minutes.

All ranges disclosed herein are inclusive of the endpoints, and the endpoints are independently combinable with each other (e.g., ranges of “up to 25 wt. %, or, more specifically, 5 wt. % to 20 wt. %”, is inclusive of the endpoints and all intermediate values of the ranges of “5 wt. % to 25 wt. %,” etc.). “Combination” is inclusive of blends, mixtures, alloys, reaction products, and the like. Furthermore, the terms “first,” “second,” and the like, herein do not denote any order, quantity, or importance, but rather are used to d one element from another. The terms “a” and “an” and “the” herein do not denote a limitation of quantity, and are to be construed to cover both the singular and the plural, unless otherwise indicated herein or clearly contradicted by context. The suffix “(s)” as used herein is intended to include both the singular and the plural of the term that it modifies, thereby including one or more of that term (e.g., the film(s) includes one or more films). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present or capable of being combined with proper elements in other embodiments. In addition, it is to be understood that the described elements may be combined in any suitable manner in the various embodiments.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

The foregoing has been a description of certain non-limiting preferred embodiments of the disclosed technology. Those of ordinary skill in the art will appreciate that various changes and modifications to this description may be made without departing from the spirit or scope of the present disclosed technology, as defined in the following claims.

I claim:

1. A method of fortifying a processed cereal piece with external fiber comprising:
a. providing said processed cereal piece;
b. using coating means, accritively coating said processed cereal piece with between 5% and about 50% w/w of the coated cereal piece with said fiber, wherein the step of coating comprise
adding said processed cereal pieces into a coating means;
separately adding fiber and an adhesive liquid to said coating means; and
accritively increasing the fiber content on the surface of the processed cereal piece in the coating means,
wherein 30 grams of the coated processed cereal piece have less than or equal to 100 calories and shows substantially no clouding in 250 ml. cold water after 10 seconds.

2. The method of claim 1, wherein said cereal piece is a flaked piece, a puffed cereal grain kernel, a puffed dough piece, an extruded dough piece, a baked piece, a nugget, a rolled grain piece or an amylaceous cereal bar.

3. The method of claim 1, where the fiber is added to the coating means simultaneously with the adhesive liquid.

4. The method of claim 1, where the fiber is added to the coating means sequentially to the adhesive liquid.

5. The method of claim 4, where the fiber is added to the coating means after the adhesive liquid.

6. The method of claim 4, where the fiber is added to the coating means before the adhesive liquid.

7. The method of claim 1, where the fiber is added to the coating means as an aerosol.

8. The method of claim 1 wherein said cereal is from a source that is corn, wheat, oat, barley, semolina, rice, tapioca, yucca or a combination thereof.

9. The method of claim 1, wherein said fiber is from a source material that is cellulose, microcrystalline cellulose, cocoa bran, corn bran, oat bran, oat fiber, apple pulp, pectin, psyllium, rice bran, sugar beet pulp, wheat bran, soybean fiber, hydrocolloids, pea fiber, wheat fiber, inulin, hydrolyzed inulin, guar gum, hydrolyzed guar gum, β-2-1-fructofuranose materials or mixtures thereof

10. The method of claim 1, wherein the step of coating further comprises drying said coated adhesive cereal mass.

11. The method of claim 1, wherein said fiber is soluble fiber, insoluble fiber or a combination thereof.

12. A method of fortifying a processed cereal piece, a baked or a fried food with external fiber comprising:
providing said processed cereal piece, baked or fried food;
coating said processed cereal piece, baked or fried food with between about 5% and about 50% (w/w of the coated cereal piece, baked or fried food) of said fiber, wherein the coating comprises:
adding said processed cereal pieces, baked or fried food into a coating means;
adding a fiber into said coating means;
adding tackifying means into the coating means;
accretively adhering the fiber onto said processed cereal piece, baked or fried food; and
coating the fiber-adhered fortified processed cereal piece, baked or fried food with a sealer coat, thereby fortifying the processed cereal piece, baked or fried food with said fiber, wherein 30 grams of the fiber-adhered fortified processed cereal piece have less than or equal to 100 calories and shows substantially no clouding in 250 ml. cold water after 10 seconds.

13. The method of claim 12, wherein said fiber is from a source material that is cellulose, microcrystalline cellulose, cocoa bran, corn bran, soluble corn bran, oat bran, oat fiber, apple pulp, pectin, psyllium, rice bran, sugar beet pulp, wheat bran, soybean fiber, hydrocolloids, pea fiber, wheat fiber, inulin, hydrolyzed inulin, guar gum, hydrolyzed guar gum, β-2-1-fructofuranose materials or mixtures thereof.

14. The method of claim 12, wherein said processed cereal piece is a flaked piece, a puffed cereal grain kernel, a puffed dough piece, an extruded dough piece, a baked piece, a nugget, a rolled grain piece or an amylaceous cereal bar.

15. The method of claim 12, wherein said sealer coat is a syrup, a sugar melt, a soluble fiber solution, a fat, an oil, a polymeric sealer or a combination thereof.

16. The method of claim 12, where the fiber is added to the coating means simultaneously with the tackifying means.

17. The method of claim 12, where the fiber is added to the coating means sequentially to the tackifying means.

18. The method of claim 17, where the fiber is added to the coating means after the tackifying means.

19. The method of claim 1, where the fiber is added to the coating means before the tackifying means.

20. The method of claim 1, wherein the fiber is not added to the processed cereal piece other than by coating.
